(19) United States
(12) Patent Application Publication
(10) Pub. No.: US 2013/0291128 A1
(43) Pub. Date: Oct. 31, 2013

(54) ANONYMIZING APPARATUS AND ANONYMIZING METHOD

(71) Applicants: Naoko Ito, Minato-ku (JP); Yuki Toyoda, Tokyo (JP)

(72) Inventors: Naoko Ito, Minato-ku (JP); Yuki Toyoda, Tokyo (JP)

(73) Assignee: NEC CORPORATION, Tokyo (JP)

(21) Appl. No.: 13/824,522

(22) PCT Filed: Sep. 9, 2011
(86) PCT No.: PCT/JP2011/070618

§ 371 Date: Jul. 3, 2013

(30) Foreign Application Priority Data
Nov. 9, 2010 (JP) 2010-250600

(51) Int. Cl. G06F 21/62

(52) U.S. Cl. CPC G06F 21/6254
USPC 726/30

(57) ABSTRACT

It is an object of the present invention to enable appropriate generalization of attribute information even when data sets are likely to be repeatedly provided and attribute information of a data entry added later substantially deviates from a range of values of attribute information of a known data entry. For each data entry of a data set having a plurality of data entries each including at least one attribute data forming a quasi-identifier, which is information that can identify an individual, and at least one attribute data other than the quasi-identifier, a value of the at least one attribute data forming the quasi-identifier is generalized on the basis of a predetermined generalization rule. Among the plurality of data entries included in the data set, a data entry which, when generalized on the basis of the generalization rule, becomes a factor for the data set to fail to satisfy a predetermined standard of anonymity is selected, and at least one data entry of which generalization target attribute data has a value that is common to that data entry to thereby enable the data set to satisfy the predetermined standard of anonymity is also selected. For the selected data entries, the value of the generalization target attribute data is changed to a predetermined common value irrespective of the predetermined generalization rule.

### BACKGROUND

The present invention relates to an anonymizing apparatus and an anonymizing method.

In recent years, techniques for privacy preserving data publication for enabling secondary use of personal information (microdata) owned by a company while preserving privacy of users attract attention. Non-Patent Document 1 introduces a technique for privacy preserving data publication. Among various kinds of user information (microdata), a set of attribute information that can identify individuals by being combined with other background knowledge is referred to as quasi-identifier. Attribute information that a user does not desire to disclose is referred to as sensitive data. In anonymization, which is one of the techniques for privacy preserving data publication, not only an explicit user identifier is deleted but also attribute information forming a quasi-identifier is made ambiguous to make it impossible to identify an individual from a combination of these kinds of attribute information or make it possible to weaken association between the quasi-identifier and sensitive data, to thereby improve anonymity of user information.

Specific operation for anonymization includes generalization for replacing data with a higher-order concept, suppression for suppressing data, anatomization for dividing a table and weakening association of identification information and secret information, permutation for exchanging identification information and secret information in a group of data, quasi-identifiers of which are the same when the data are generalized, and perturbation for adding noise or the like to data. In the generalization, which is the most general method among these kinds of operation, data entries are grouped according to attributes of quasi-identifiers, attribute values of the quasi-identifiers are generalized for each of the groups, and the same generalized quasi-identifier is given to the data entries belonging to the same quasi-identifier group.

As a basic index used for evaluation of privacy preservation by the generalization, there is k-anonymity. The k-anonymity indicates that k or more data entries having the same generalized quasi-identifiers are present. Further, an index called I-diversity indicates that I or more kinds of values of sensitive data are present in data entries having the same generalized quasi-identifier. Basically, as values of k and l are larger, privacy is considered to be more strongly preserved. A method of realizing, while suppressing a loss of information, generalization for increasing the values of k and l has been studied.

The k-anonymity and the l-diversity are the indexes of privacy preservation that focuses on single provision of a generalized data set. Further, Non-Patent Document 2 proposes an index called m-invariance that takes into account a risk of privacy leakage by combining, when data are provided a plurality of times, generalized data sets of these data. The m-invariance indicates that m or more data entries having different sensitive data values are present in all quasi-identifier groups included in continuously-issued generalized data sets and indicates that sets of values of sensitive data included in generalized quasi-identifier groups to which the data entries present across a plurality of generalized data sets belong are the same. If the m-invariance is guaranteed, the I-diversity is simultaneously satisfied. In order to guarantee the m-invariance, a method of performing generalization of quasi-identifier groups after adding a false entry is proposed.

Non-Patent Document 1: Chen, B.; Kifer, D.; Lefevre, K.; Machanavajjhala, A., “Privacy-Preserving Data Publishing”, Foundations and Trends in Databases, 2009, Volume 2, p. 1 to 167

Non-Patent Document 2: X. Xiao and Y. Tao, “m-invariance: Towards privacy preserving re-publication of dynamic datasets”, Proceedings of the ACM SIGMOD International Conference on Management of Data, 2007

However, for example, when data sets are repeatedly provided, attribute information of a data entry added later is likely to substantially deviate from an initially-assumed range of values.

When these values are attributes forming quasi-identifiers, with the conventional method of generalization, it is difficult to guarantee the k-anonymity and apply meaningful generalization. Therefore, it is necessary to remove an added data entry from target data or perform generalization having a considerably high level of abstraction. As a result, an information loss is caused.

There is also a problem in that, when, every time a change occurs in a data set, anonymization adapted to a characteristic of the data set is carried out, a method of generalization of quasi-identifiers is different for each of data sets, groups to which respective data entries belong are completely different, and it is difficult to observe characteristics of the data sets in time series and track specific data entries in time series.

For example, FIG. 23 shows an original data set. In this data set, attributes forming a quasi-identifier are sex and a birthplace. A disease name is sensitive data. A generalization rule for birthplaces shown in FIGS. 24 and 25 are applied to the data set, whereby generalization is performed and a data set after generalization shown in FIG. 26 is obtained. As shown in FIG. 26, the data set after the generalization satisfies anonymity of k=2 and diversity of l=2.

FIG. 27 shows a data entry added later to the data set shown in FIG. 23. A value of a birthplace of the data entry added later is “London”, which is a value that cannot be generalized according to the generalization rule shown in FIGS. 24 and 25. Therefore, a new generalization rule for generalizing this value is necessary.

An example of the new generalization rule is shown in FIGS. 28 to 30. When the value “London” is generalized according to the rule shown in FIGS. 28 to 30, a data entry after the generalization is a data entry shown in FIG. 31. However, the data entry shown in FIG. 31 shares a generalized quasi-identifier with none of the data entries shown in FIG. 26 and does not belong to an existing generalization group. Therefore, in order to obtain a data set after generalization that satisfies the anonymity of k=2 and the diversity of l=2, there is no choice but to omit the added data entry.

Alternatively, it is necessary to apply the new generalization rule, which takes into account the added data entry, to existing data entries as well. For example, as shown in FIG. 32, it is necessary to introduce a concept “earth” that covers all birthplaces and introduce a generalization rule with a high abstraction level. There is a problem in that, when the generalization based on the rule is performed to keep the anonymity of k=2 and the diversity of l=2, as shown in FIG. 33, values of the birthplace of all the data entries are “earth” and the values of the birthplace are meaningless.

Alternatively, as shown in FIGS. 34 and 35, it is also possible to apply the generalization rule at the “earth” level to only a part of the data entries. In this case, as shown in FIG. 36, it is possible to keep the meaning of the values of the birthplace as much as possible. However, there is a problem in that, when optimum generalization processing is independently carried out for each time, like an eighth data entry, a group to which the same entries belong is different for each of snap shots and it is difficult to track characteristics of data sets in time series.

### SUMMARY

The present invention has been devised in view of such circumstances and it is an object of the present invention to enable appropriate generalization of attribute information even when data sets are likely to be repeatedly provided and attribute information of a data entry added later substantially deviates from a range of values of attribute information of a known data entry.

An anonymizing apparatus according to an aspect of the present invention includes: a generalizing unit configured to generalize, for each data entry of a data set having a plurality of data entries each including at least one attribute data forming a quasi-identifier, which is information that can identify an individual, and at least one attribute data other than the quasi-identifier, a value of the at least one attribute data forming the quasi-identifier on the basis of a predetermined generalization rule; an entry selecting unit configured to select, among the plurality of data entries included in the data set, a data entry which, when generalized on the basis of the generalization rule, becomes a factor for the data set to fail to satisfy a predetermined standard of anonymity, and at least one data entry of which generalization target attribute data has a value that is common to that data entry to thereby enable the data set to satisfy the predetermined standard of anonymity; and an entry processing unit configured to change, for the data entries selected by the entry selecting unit, the value of the generalization target attribute data to a predetermined common value irrespective of the predetermined generalization rule.

In the present invention, “unit” does not simply means physical means and includes a function of the “unit” realized by software. A function of one “unit” or apparatus may be realized by two or more physical means or apparatuses or functions of two or more “units” or apparatuses may be realized by one physical means or apparatus.

According to the present invention, it is possible to perform appropriate generalization of attribute information even when data sets are likely to be repeatedly provided and attribute information of a data entry added later substantially deviates from a range of values of attribute information of a known data entry.

### DESCRIPTION OF THE DRAWINGS

FIG. 1 is a diagram showing a configuration example of an anonymizing apparatus according to an embodiment of the present invention.

FIG. 2 is a diagram showing an example of a flow of processing in the anonymizing apparatus.

FIG. 3 is a diagram showing an example of a flow of processing in the anonymizing apparatus.

FIG. 4 is a diagram showing an example of a data set including data entries in which values of a birthplace are changed.

FIG. 5 is a diagram showing an example of a data entry in which a value of the birth place is changed.

FIG. 6 is a diagram showing an example of a data set including data entries in which values of sex and the birth place are changed.

FIG. 7 is a diagram showing an example of a data entry in which values of the sex and the birthplace are changed.

FIG. 8 is a diagram showing an example of a data set in which data entries are added.

FIG. 9 is a diagram showing an example of a data entry to be added.

FIG. 10 is a diagram showing an example of a data set including data entries in which values of the sex and the birthplace are changed to original values.

FIG. 11 is a diagram showing an example of a data entry to be added.

FIG. 12 is a diagram showing an example of an original data set at time T.

FIG. 13 is a diagram showing an example of an original data set at time T+1.

FIG. 14 is a diagram showing an example of an original data set at time T+2.

FIG. 15 is a diagram showing an example of a processed data set at the time T.

FIG. 16 is a diagram showing an example of a processed data set at the time T+1.

FIG. 17 is a diagram showing an example of a processed data set at the time T+2.

FIG. 18 is a diagram showing another configuration example of the anonymizing apparatus.

FIG. 19 is a diagram showing still another configuration example of the anonymizing apparatus.

FIG. 20 is a diagram showing still another configuration example of the anonymizing apparatus.

FIG. 21 is a diagram showing still another configuration example of the anonymizing apparatus.

FIG. 22 is a diagram showing still another configuration example of the anonymizing apparatus.

FIG. 23 is a diagram showing an example of an original data set.

FIG. 24 is a diagram showing an example of a generalization rule.

FIG. 25 is a diagram showing an example of the structure of the generalization rule.

FIG. 26 is a diagram showing an example of a generalized data set.

FIG. 27 is a diagram showing an example of a data entry to be added.

FIG. 28 is a diagram showing an example of a generalization rule.

FIG. 29 is a diagram showing an example of the structure of the generalization rule.

FIG. 30 is a diagram showing an example of the structure of the generalization rule.

FIG. 31 is a diagram showing an example of a generalized data entry.

FIG. 32 is a diagram showing an example of a generalization rule.

FIG. 33 is a diagram showing an example of a generalized data set.

FIG. 34 is a diagram showing an example of a generalization rule.

FIG. 35 is a diagram showing an example of the structure of the generalization rule.

FIG. 36 is a diagram showing an example of a generalized data set.

### DETAILED DESCRIPTION

An embodiment of the present invention is explained below with reference to the drawings.

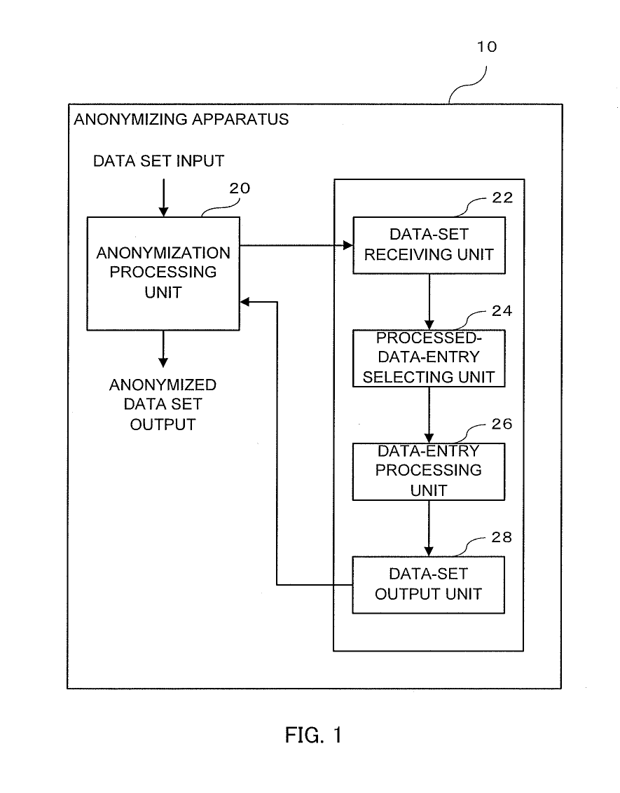

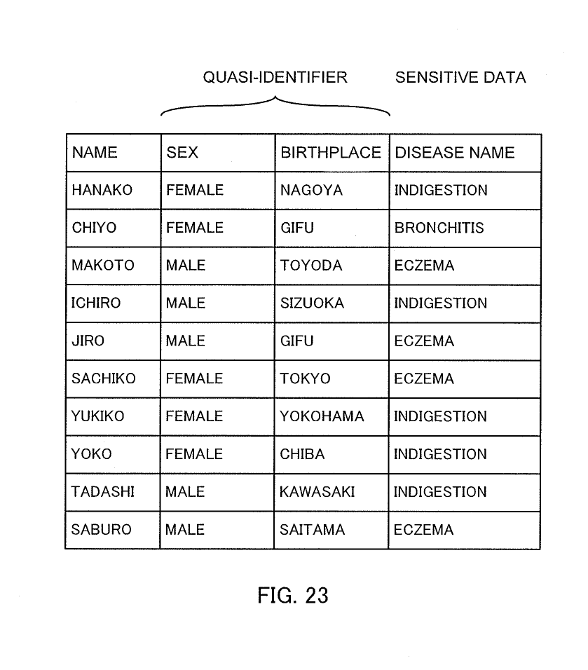

FIG. 1 is a diagram showing a configuration example of an anonymizing apparatus according to the embodiment of the present invention. An anonymizing apparatus 10 is, for example, an apparatus that applies anonymization to a data set shown in FIG. 23 having data entries including attribute data that can identify individuals. The anonymizing apparatus 10 is an information processing apparatus such as an application server. The anonymizing apparatus 10 includes a processor, a memory, an input device, and a storage device.

As shown in FIG. 1, the anonymizing apparatus 10 includes an anonymization processing unit 20, a data-set receiving unit 22, a processed-data-entry selecting unit 24, a data-entry processing unit 26, and a data-set output unit 28 as functional units. These functional units are realized by, for example, a processor executing a program stored in a memory.

The anonymization processing unit 20 (a generalizing unit) executes anonymization processing such as generalization, suppression, and permutation on an input data set and outputs an anonymized data set. For example, the anonymization processing unit 20 performs generalization of attribute data included in respective data entries according to a predetermined generalization rule.

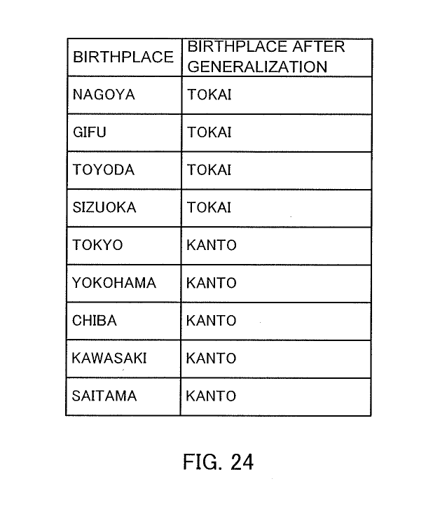

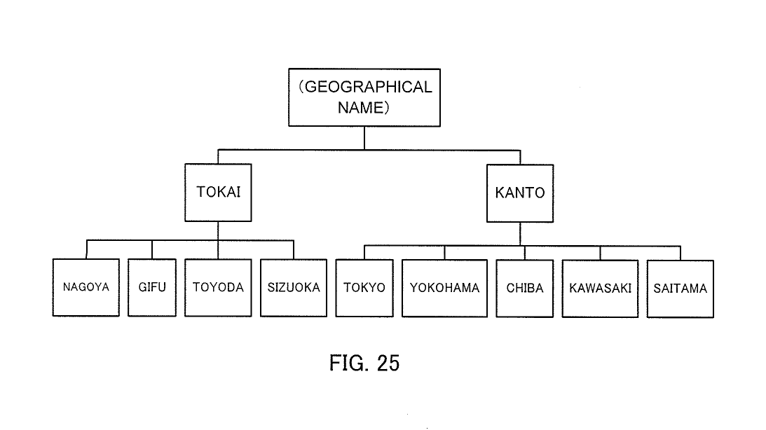

For example, in the case of the data set shown in FIG. 23, sex and a birthplace are a set of information that can identify an individual by being combined with other background knowledge. The sex and the birthplace form a quasi-identifier. The anonymization processing unit 20 performs, for respective data entries of the data set shown in FIG. 23, generalization of values of the birthplace among attribute data forming quasi-identifiers according to, for example, a generalization rule shown in FIGS. 24 and 25.

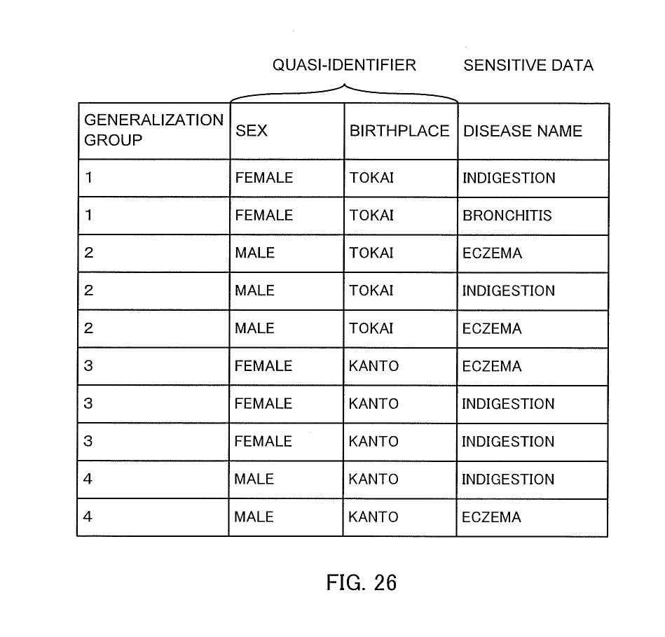

FIG. 26 shows an example of a data set obtained by generalizing the data set shown in FIG. 23. For example, in a first data entry, the birthplace “Nagoya” is generalized to “Tokai”. The other data entries are generalized in the same manner, whereby generalization groups by the quasi-identifiers are formed. For example, in first and second data entries in the data set after the generalization, the sex is “female” and the birthplace is “Tokai”. The first and second data entries form one generalization group. The anonymization processing unit 20 gives, to the generalization groups formed by the generalization, identifiers for identifying the generalization groups.

A method for the generalization is not limited to abstraction of a meaning of a word. For example, processing for increasing granularity of numerical values or the like, for example, converting an age to “thirties” or “twenty-five to thirty-five years old” or processing for converting location information such as the latitude and the longitude into data in an appropriate range (region) may be used for the generalization.

Referring to the data set shown in FIG. 26, two or more data entries are present in each of the generalization groups. Anonymity of k=2 is satisfied. Two or more kinds of values of “disease name”, which is sensitive data, are included in each of the generalization groups. Diversity of l=2 is satisfied. In the anonymizing apparatus 10, a predetermined standard of anonymity is set for k-anonymity, l-diversity, and the like. In this embodiment, it is assumed that, in the anonymizing apparatus 10, the anonymity of k=2 and the diversity of l=2 are set as predetermined standards of anonymity.

Referring back to FIG. 1, the data-set receiving unit 22 receives a data set before generalization or after the generalization from the anonymization processing unit 20 and outputs the data set to the processed-data-entry selecting unit 24.

The processed-data-entry selecting unit 24 selects, among a plurality of data entries included in an input data set, a data entry with which the data set is unable to satisfy the predetermined standards of anonymity when the data entry is generalized on the basis of the generalization rule in the anonymization processing unit 20, and at least one data entry other than the data entry. The data entry with which the data set is unable to satisfy the predetermined standards of anonymity when the data entry is generalized on the basis of the generalization rule, is, for example, a data entry that does not belong to any generalization group in the data set and becomes a target of suppression when a quasi-identifier thereof is generalized on the basis of the generalization rule. The at least one data entry is, for example, a plurality of data entries in which values of attribute data not generalized on the basis of the generalization rule among a plurality of attribute data forming a quasi-identifier are different or at least one data entry with which the data set satisfies the predetermined standards of anonymity even if the data entry is removed from the data set. Details are explained below with reference to a specific example.

The data-entry processing unit 26 changes, for the data entries selected by the processed-data-entry selecting unit 24, values of generalization target attribute data to a predetermined common value and outputs the value to the anonymization processing unit 20 via the data-set output unit 28. For example, the data-entry processing unit 26 can change values of the birthplace of the selected data entry to “*”. The predetermined common value after the change can be, for example, a value with a highest abstraction level that the attribute data can take. For example, in the case of the birthplace, the predetermined common value after the change can be “earth”.

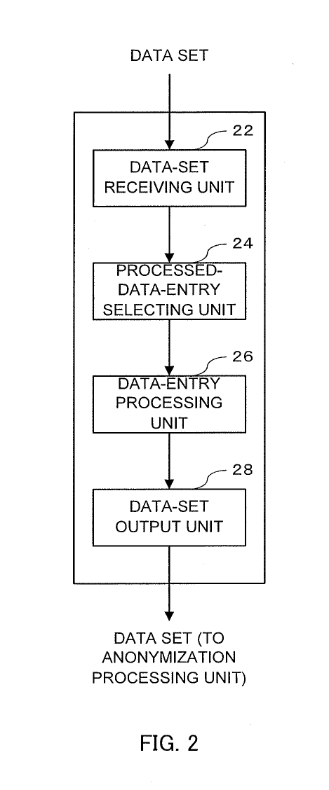

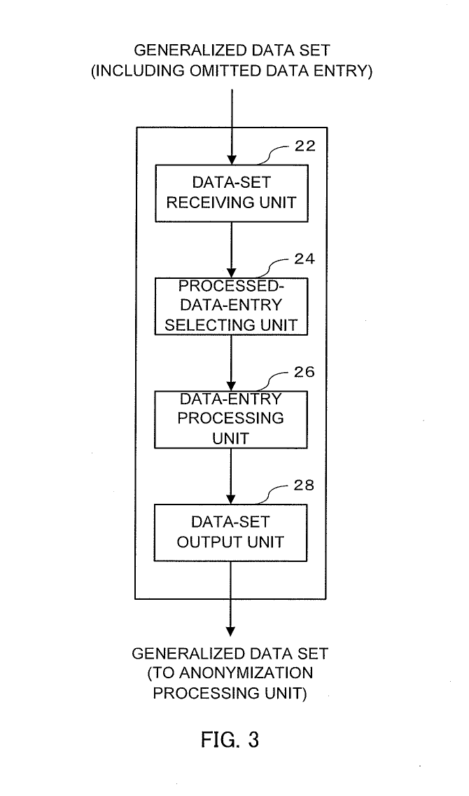

FIGS. 2 and 3 are diagrams showing an example of a flow of processing in the anonymizing apparatus 10. As shown in FIG. 2, processing for a data set can be applied to the data set before the generalization in the anonymization processing unit 20. As shown in FIG. 3, it is also possible to apply the processing to the data set after the generalization in the anonymization processing unit 20. The processing may be executed a plurality of times halfway in anonymization, for example, the processing for the data set may be dividedly performed twice, i.e., before the generalization and after the generalization.

In an example explained in this embodiment, the processing is applied to the data set after the generalization. First, it is assumed that, in the anonymization processing unit 20, the generalization rule shown in FIG. 24 is set. When the data set shown in FIG. 23 is input to the anonymization processing unit 20, values of the birthplace are generalized on the basis of the generalization rule and the data set shown in FIG. 26 is obtained. As explained above, the data set shown in FIG. 26 satisfies the standard of anonymity in the anonymizing apparatus 10. On the premise of this state, an example concerning data processing is explained below.

### <Data Processing Example 1>

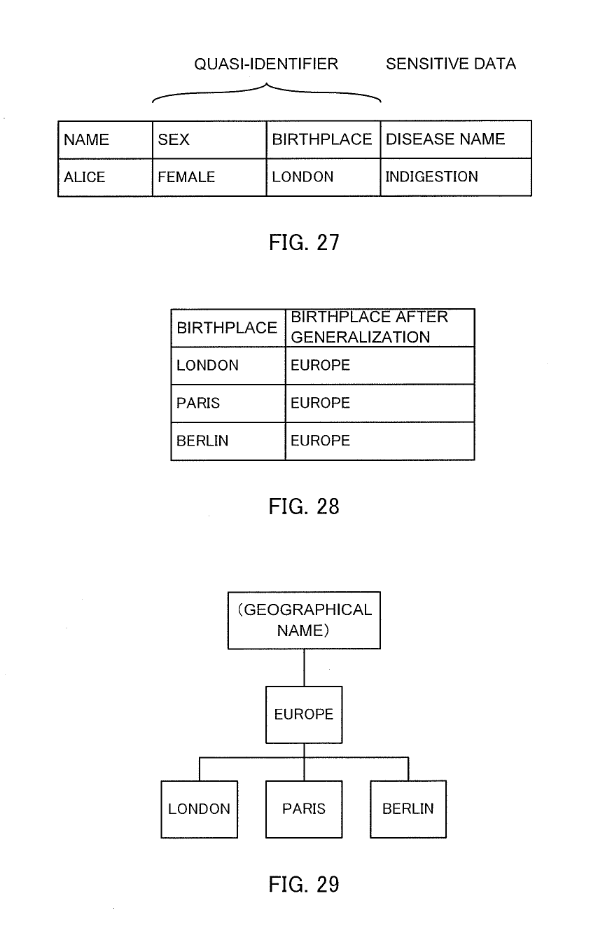

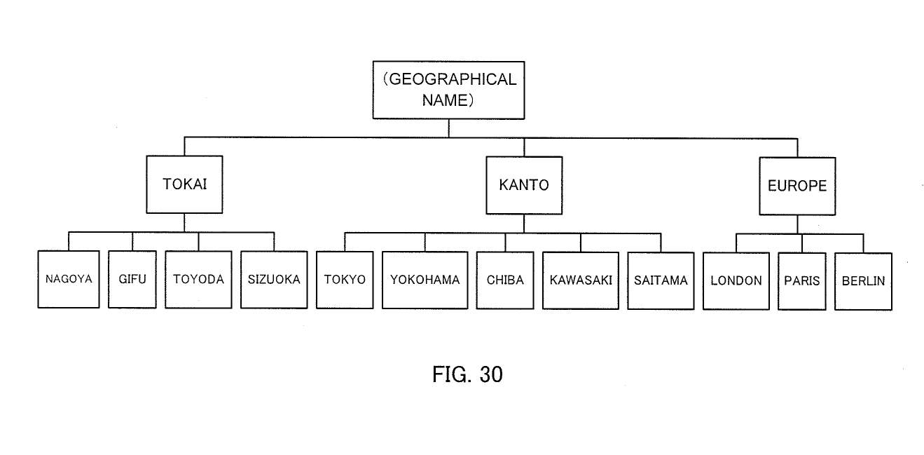

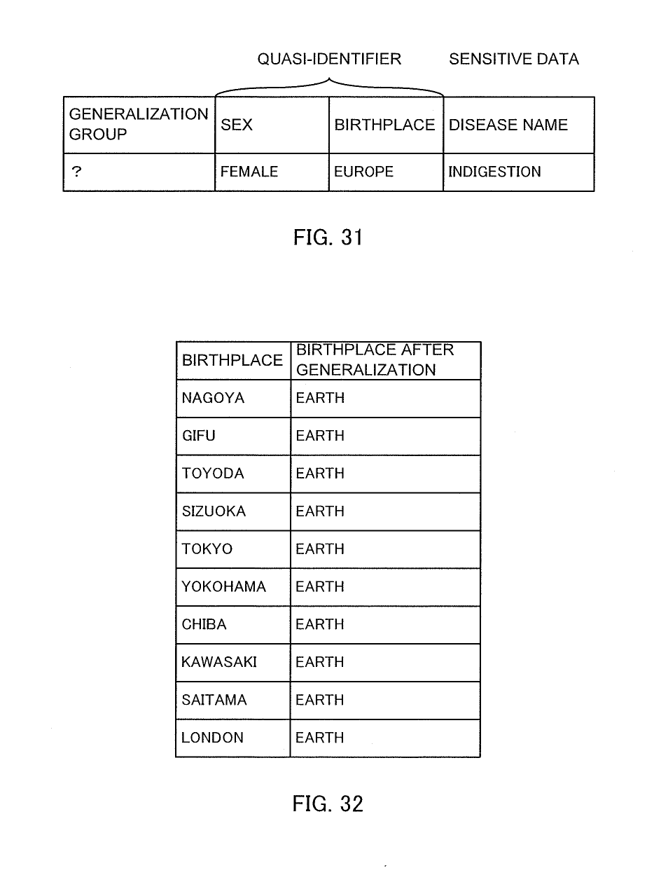

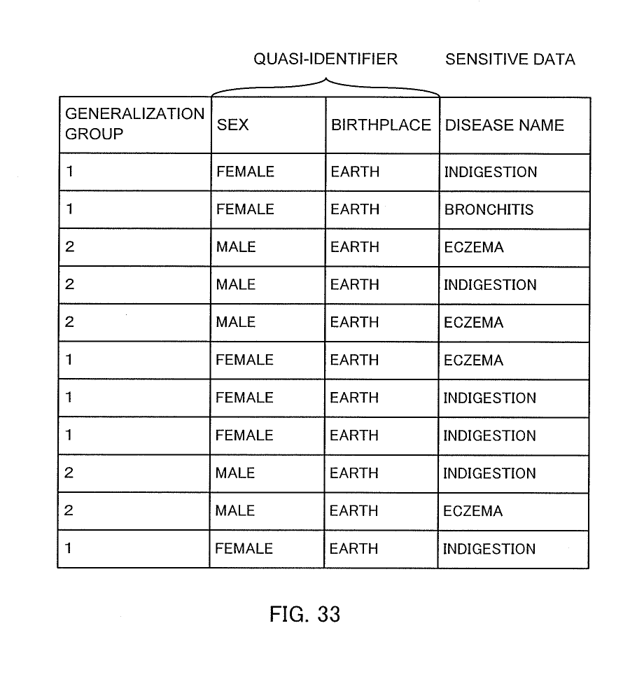

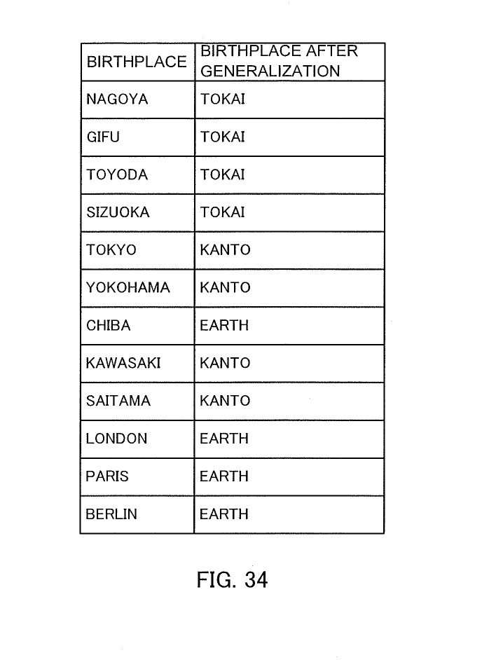

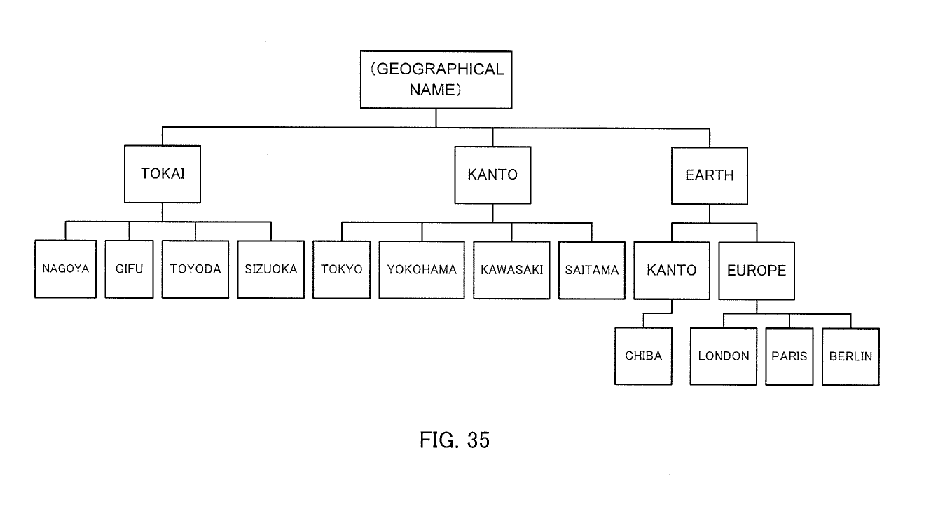

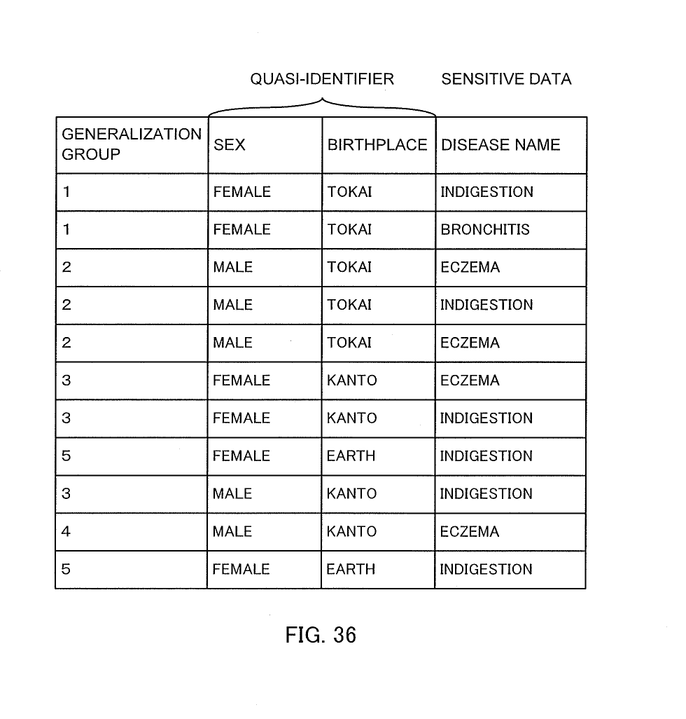

It is assumed that, after the data set shown in FIG. 26 is obtained, a data entry shown in FIG. 27 is input to the anonymization processing unit 20 as an additional entry to the data set. A birthplace of the data entry shown in FIG. 27 is “London”, which cannot be generalized according to the generalization rule shown in FIG. 24. As a result, when the data entry is added, the standard of anonymization is not satisfied. Therefore, the anonymization processing unit 20 outputs, to the data-set receiving unit 22, a data set formed by the data set after the generalization shown in FIG. 26 and the data entry shown in FIG. 27.

The data-set receiving unit 22 receives the data set from the anonymization processing unit 20 and outputs the data set to the processed-data-entry selecting unit 24.

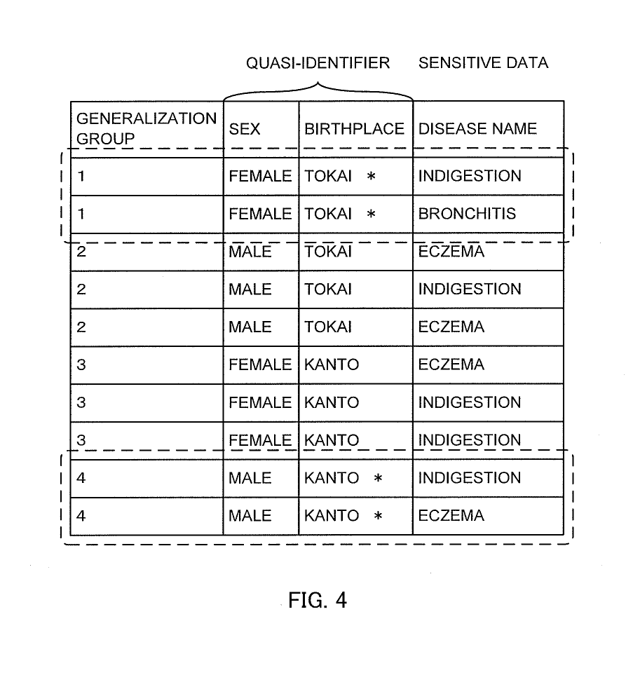

The processed-data-entry selecting unit 24 selects, among a plurality of data entries included in the data set, a data entry with which the data set is unable to satisfy the standard of anonymity when the data set is generalized on the basis of the generalization rule, and a plurality of data entries having different values of attribute data not generalized on the basis of the generalization rule among a plurality of attribute data forming a quasi-identifier. The data entry, with which the data set is unable to satisfy the standard of anonymity when the data entry is generalized on the basis of the generalization rule, is the data entry shown in FIG. 27. Examples of the plurality of data entries having the different values of the attribute data not generalized on the basis of the generalization rule among the plurality of attribute data forming the quasi-identifier are data entries surrounded by broken lines in FIG. 4. In other words, attribute data not generalized among the attribute data forming the quasi-identifier is sex. A plurality of data entries having different values of the sex are selected. In the example shown in FIG. 4, data entries, the sex of which is “female” and the generalization group of which is “1”, and data entries, the sex of which is “male” and the generalization group of which is “4”, are selected.

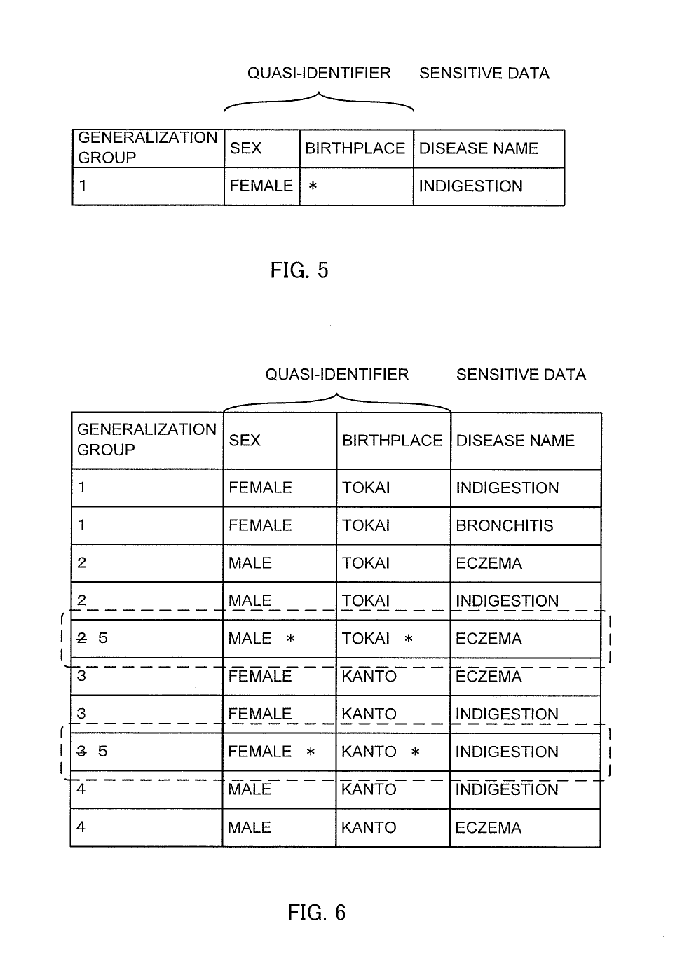

The data-entry processing unit 26 changes the values of the birthplace of the data entries selected by the processed-data-entry selecting unit 24 to, for example, “*” as shown in FIGS. 4 and 5. The processing for the data set shown in FIG. 26 may be performed in advance before the data entry shown in FIG. 27 is added or may be performed at timing when the data entry shown in FIG. 27 is added.

The data-set output unit 28 outputs the data set processed by the data-entry processing unit 26 to the anonymization processing unit 20.

As shown in FIGS. 4 and 5, according to the data processing by the data-entry processing unit 26, the quasi-identifier of the data entry shown in FIG. 5 is the same as the quasi-identifier, the generalization group of which is “1” in the data set shown in FIG. 4. Therefore, in the anonymization processing unit 20, for example, “1” is given to the generalization group of the data entry shown in FIG. 5. Consequently, without omitting the added data entry and without generalizing the birthplace to a meaningless level, it is possible to allow the data set to satisfy the standard of anonymity.

In other words, when the generalization is applied to the data set, a more abstract generalization rule is intendedly applied to a part of data entries to which a more specific generalization rule can be applied. Consequently, irrespective of what kind of value a data entry to be added later takes, it is possible to add the data entry to the generalized data set while keeping the standard of anonymity.

As shown in FIG. 4, the processed-data-entry selecting unit 24 selects data entries in a generalization group unit. Consequently, since the number of data entries of each of the generalization groups does not decrease, it is possible to prevent the standard of anonymity from being not satisfied.

### <Data Processing Example 2>

In this example, as in the example explained above, it is assumed that, after the data set shown in FIG. 26 is obtained, the data entry shown in FIG. 27 is input to the anonymization processing unit 20 as an additional entry to a data set.

The data-set receiving unit 22 receives the data set from the anonymization processing unit 20 and outputs the data set to the processed-data-entry selecting unit 24.

The processed-data-entry selecting unit 24 selects, among a plurality of data entries included in the data set, a data entry with which the data set is unable to satisfy the predetermined standards of anonymity when the data entry is generalized on the basis of the generalization rule, and at least one data entry with which the data set satisfies the standard of anonymity even if the data entry is excluded from the data set. Examples of the at least one data entry, with which the data set satisfies the predetermined standards of anonymity even if the data entry is excluded from the data set, are data entries surrounded by broken lines in FIG. 6. As shown in FIG. 6, the generalization group of third to fifth data entries is “2”. Among the data entries, even if the fifth data entry is excluded, the standard of anonymity is satisfied by the third and fourth data entries. Similarly, among sixth to eighth data entries, the generalization group of which is “3”, even if the eighth data entry is excluded, the standard of anonymity is satisfied.

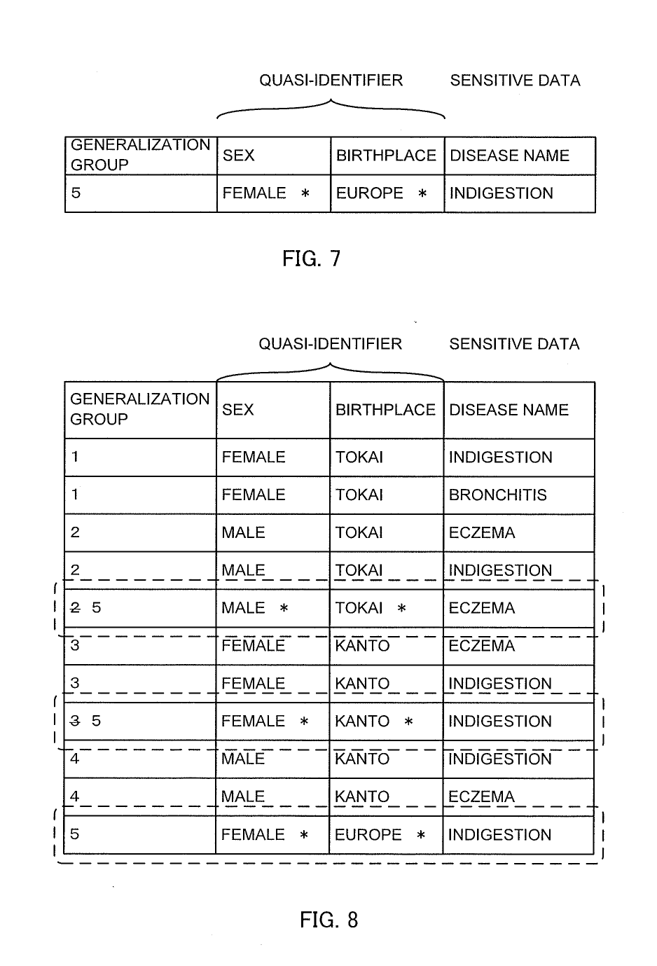

The data-entry processing unit 26 changes values of the sex and the birthplace of the data entries selected by the processed-data-entry selecting unit 24 to, for example, “*” as shown in FIGS. 6 and 7. The data-entry processing unit 26 may change the values of the sex and the birthplace respectively to other predetermined common values.

The data-set output unit 28 outputs the data set processed by the data-entry processing unit 26 to the anonymization processing unit 20.

As shown in FIGS. 6 and 7, according to the data processing by the data-entry processing unit 26, the quasi-identifier of the data entry shown in FIG. 7 is the same as the quasi-identifier of the data entries selected from the data set shown in FIG. 6. Therefore, in the anonymization processing unit 20, “5” is given to these data entries. Consequently, without omitting the added data entry and without generalizing the birthplace to a meaningless level, it is possible to allow the data set to satisfy the standard of anonymity.

The data-entry processing unit 26 may change only a value of the birthplace, which is generalization target attribute data, to “*”. However, by changing a value of the sex, which is the other attribute data included in the quasi-identifier, to “*” as well, it is possible to increase the possibility that a new generalization group is formed by the processed data entries and the added data entry.

### <Data Processing Example 3>

This example is an example in which a data entry is further added to the data set processed by the data processing example 2. FIG. 8 shows the data set processed by the data processing example 2. In this example, it is assumed that a generalization rule of “Europe” shown in FIG. 28 is also applied. Specifically, as shown in FIG. 8, a value before change of the birthplace of an eleventh entry is “Europe” obtained by generalizing “London”, which is the value of the birthplace of the data entry shown in FIG. 27, according to the generalization rule shown in FIG. 28.

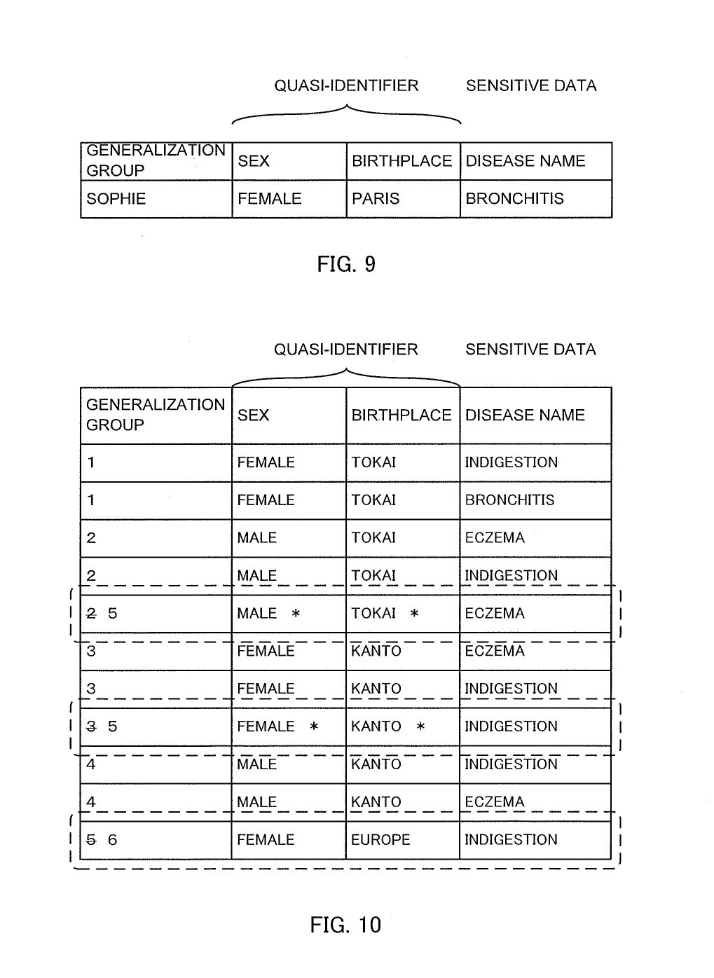

It is assumed that, after the data set shown in FIG. 8 is obtained, a data entry shown in FIG. 9 is input to the anonymization processing unit 20 as an additional entry to the data set. A value of the birthplace of the data entry shown in FIG. 9 is “Paris”. When the data entry is generalized by the anonymization processing unit 20, the value of the birthplace is generalized to “Europe” and the standard of anonymity is not satisfied. Therefore, the anonymization processing unit 20 outputs, to the data-set receiving unit 22, a data set formed by the data set after the generalization shown in FIG. 8 and the data entry shown in FIG. 9.

The data-set receiving unit 22 receives the data set from the anonymization processing unit 20 and outputs the data set to the processed-data-entry selecting unit 24.

The processed-data-entry selecting unit 24 selects, among a plurality of data entries included in the data set, an added entry, i.e., a data entry with which the data set is unable to satisfy the predetermined standards of anonymity when the data entry is generalized on the basis of the generalization rule, and a data entry that, if values of attribute data of which are returned to values before processing, forms a generalization group together with the added entry, whereby the standard of anonymity is satisfied.

Referring to the data set shown in FIG. 8, in the eleventh data entry, values before processing of the sex and the birthplace are respectively “female” and “Europe” and a value of the sensitive data is “indigestion”. Values before processing of the attribute data can be obtained by, for example, generalizing the attribute data of the data entry before generalization according to the generalization rule. For example, a storing unit may be provided that stores the values of the attribute data before the processing in association with the entries, the attribute data of which is processed, separately from the data entry before the generalization.

In the data entry shown in FIG. 9, values of the sex and the birthplace are respectively “female” and “Paris” and a value of the sensitive data is “bronchitis”. Specifically, if the values of the sex and the birthplace of the eleventh data entry in the data set shown in FIG. 8 are respectively returned to “female” and “Europe” before the processing and the birthplace of the data entry shown in FIG. 9 is generalized, a new generalization group that satisfies the standard of anonymity is formed by the two data entries.

Therefore, the data-entry processing unit 26 changes the values of the sex and the birthplace of the eleventh data entry in the data set shown in FIG. 8, which is selected by the processed-data-entry selecting unit 24, respectively to “female” and “Europe” before the processing. FIG. 10 shows the processed data set.

The data-set output unit 28 outputs the data set processed by the data-entry processing unit 26 to the anonymization processing unit 20.

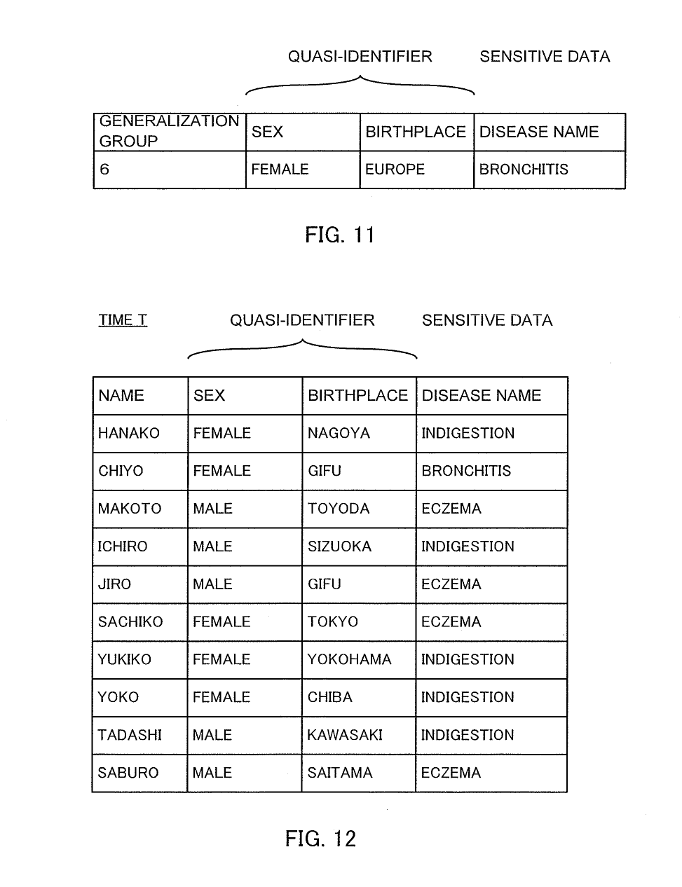

When the data entry shown in FIG. 9 is generalized in the anonymization processing unit 20, a data entry shown in FIG. 11 is obtained. A new generalization group is formed by the data entry and the eleventh data entry of the data set shown in FIG. 10. In other words, for example, “6” is given to the generalization group of these data entries.

### <Data Processing Example 4>

In this example, an example in which addition and deletion of a data entry are performed is explained. FIGS. 12 to 14 show examples of data sets before anonymization in times T to T+2.

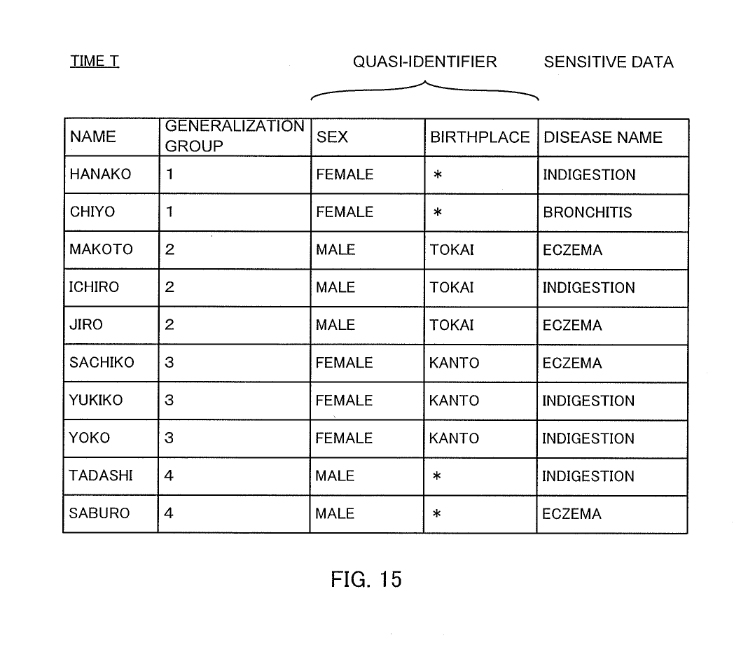

First, a data set obtained by applying generalization of values of the birthplace to a data set shown in FIG. 12 and performing processing of data in the same manner as the data processing example 1 is shown in FIG. 15.

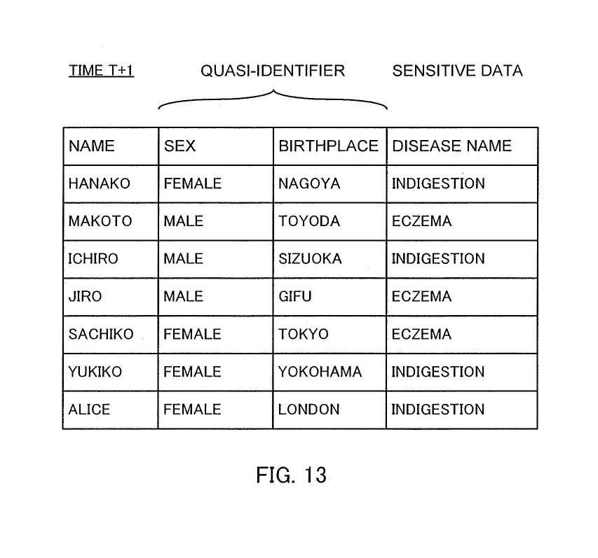

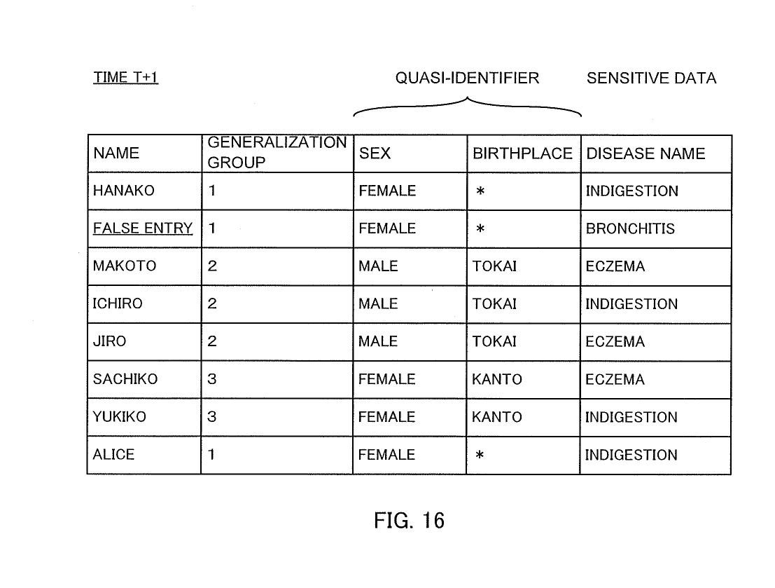

It is assumed that the original data changes at time T+1 as shown in FIG. 13. Specifically, data entries of “Chiyo”, “Yoko”, “Tadashi”, and “Saburo” are deleted from the original data set at time T and a data entry of “Alice” is added. In this case, as shown in FIG. 16, for the data entry of “Alice”, as in the case of the data processing example 1, a value of the birthplace is changed to “*”. The data entry of “Alice” is set in the same generalization group as “Hanako”. However, since the data entry of “Chiyo” is deleted and the “disease name” of both the data entries of “Hanako” and “Alice” is “indigestion”, the standard of anonymization is not satisfied. Therefore, the data-entry processing unit 26 adds a false entry data, the “disease name” of which is “bronchitis”, as shown in FIG. 16 such that the standard of anonymization is satisfied.

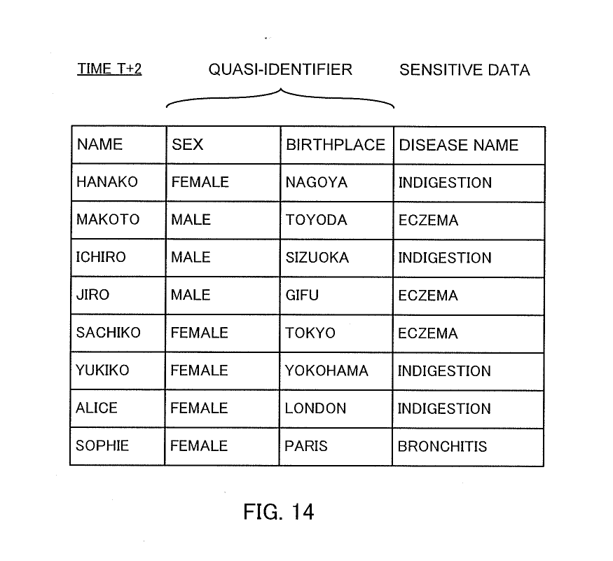

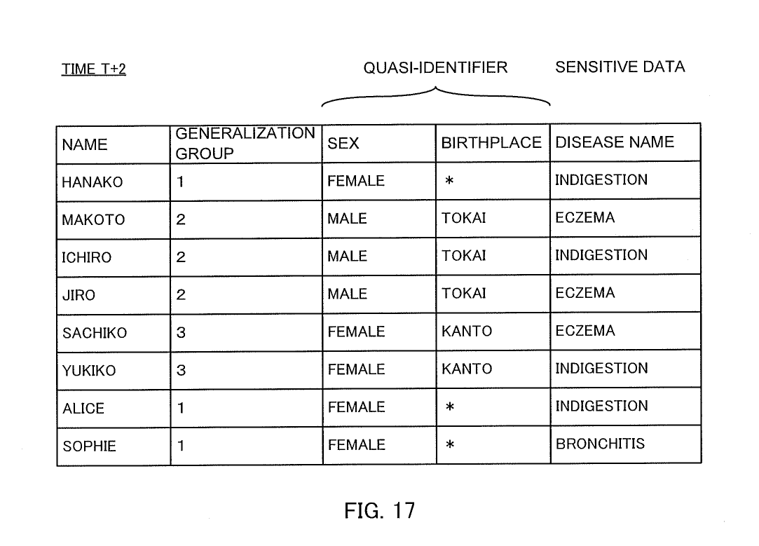

Further, it is assumed that the original data set changes as shown in FIG. 14 at time T+2. Specifically, a data entry of “Sophie” is added to the original data at time T+1. In this case, as shown in FIG. 17, for the data entry of “Sophie”, like the data entry of “Alice”, a value of the birthplace is changed to “*”. The data entry of “Sophie” is set in the same generalization group as “Hanako” and “Alice”. Since the “disease name” of the data entry of “Sophie” is “bronchitis”, even if the false data entry shown in FIG. 16 is removed, the standard of anonymization is satisfied. Therefore, as shown in FIG. 17, the false data entry is deleted by the data-entry processing unit 26.

As explained above, with the anonymizing apparatus 10 in this embodiment, it is possible to perform appropriate generalization of attribute information even when data sets are likely to be repeatedly provided and attribute information of a data entry added later substantially deviates from a range of values of attribute information of a known data entry.

This embodiment is an embodiment for facilitating understanding of the present invention and not for limitedly interpreting the present invention. The present invention can be changed/improved without departing from the spirit of the present invention. Equivalents of the present invention are included in the present invention.

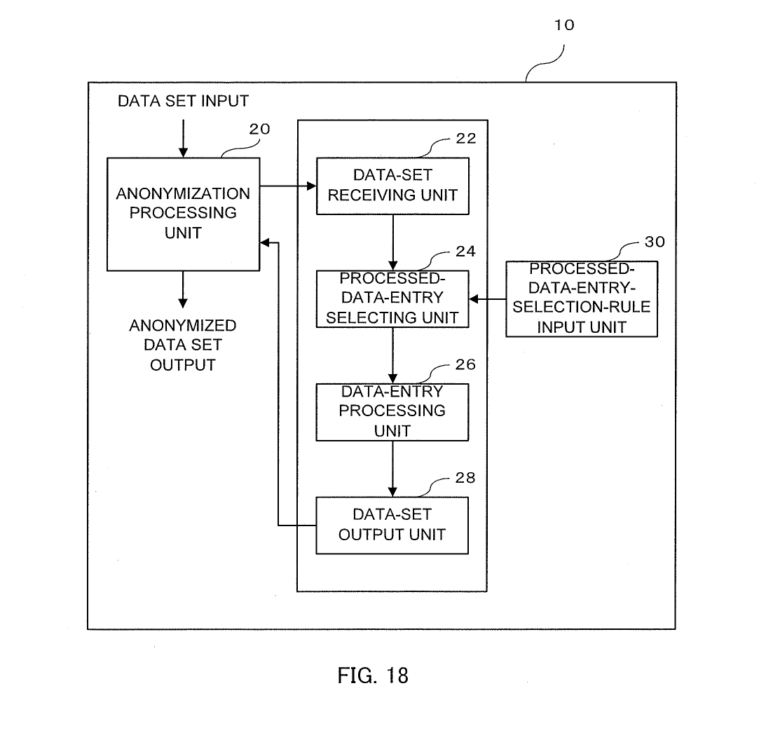

For example, as shown in FIG. 18, the anonymizing apparatus 10 may include a processed-data-entry-selection-rule input unit 30. In other words, a rule in selecting a data entry does not have to be fixed in the processed-data-entry selecting unit 24 and may be able to be changed according to an input from the processed-data-entry-selection-rule input unit 30.

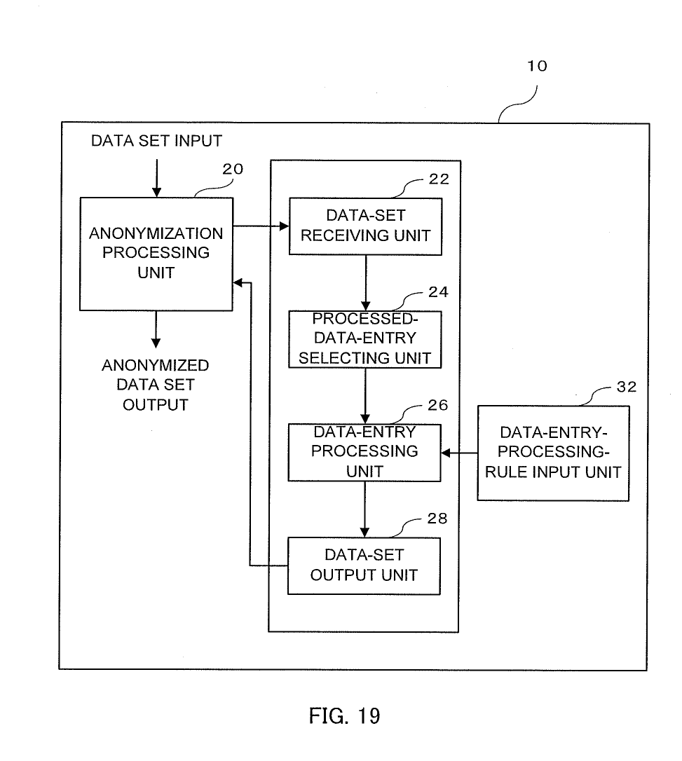

For example, as shown in FIG. 19, the anonymizing apparatus 10 may include a data-entry-processing-rule input unit 32. In other words, a rule in processing a data entry does not have to be fixed in the data-entry processing unit 26 and may be able to be changed according to an input from the data-entry-processing-rule input unit 32.

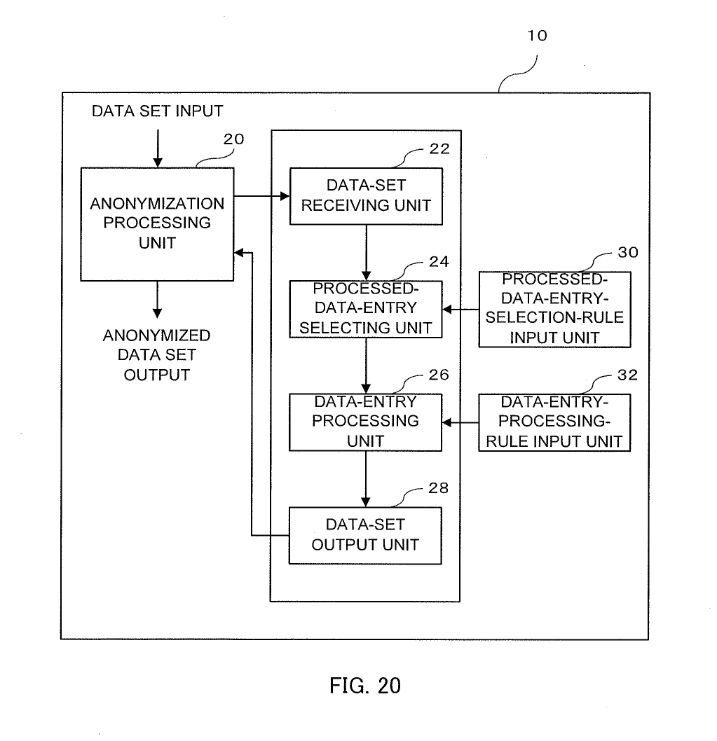

Further, for example, as shown in FIG. 20, the anonymizing apparatus 10 may include both of the processed-data-entry-selection-rule input unit 30 and the data-entry-processing-rule input unit 32.

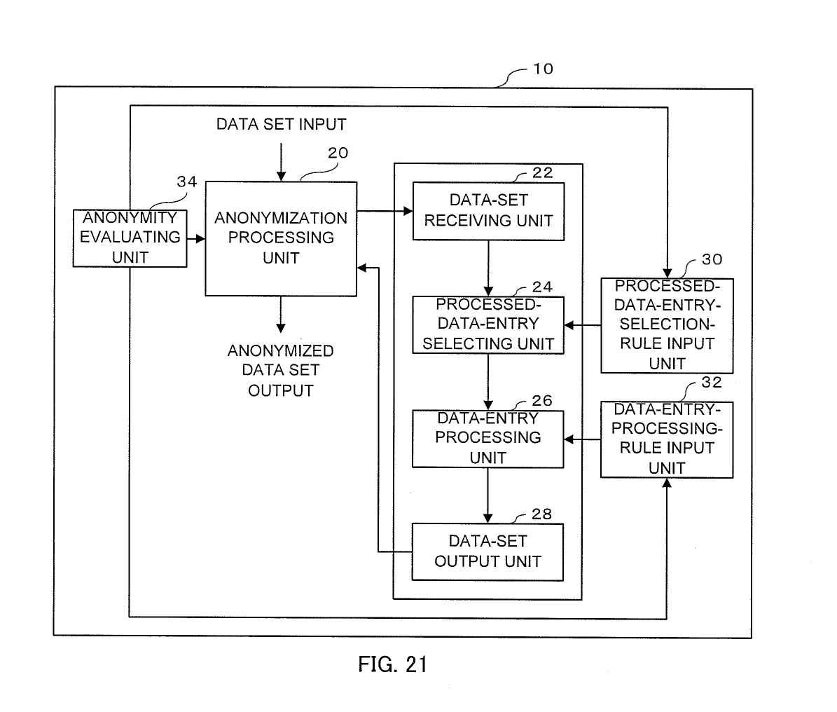

As shown in FIG. 21, the anonymizing apparatus 10 may include anonymity evaluating unit 34 for evaluating anonymity of an anonymized data set generated by anonymization by the anonymization processing unit 20. In this case, the anonymity evaluating unit 34 can control the processed-data-entry-determination-rule input unit 30 and the data-entry-processing-rule input unit 32 on the basis of an evaluation result of anonymity such that the anonymity satisfies a predetermined standard.

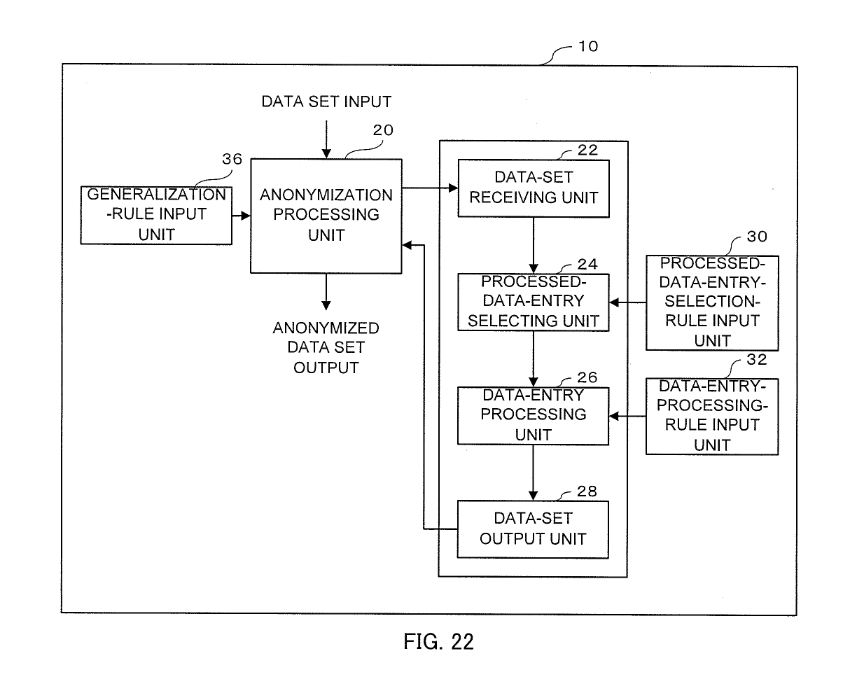

As shown in FIG. 22, the anonymizing apparatus 10 may include an anonymization-rule input unit 36. Specifically, a rule in applying the anonymization processing to a data entry may be changeable according to an input from the anonymization-rule input unit 36 rather than being fixed in the anonymization processing unit 20. For example, when the anonymization processing unit 20 does not have the anonymization rule of “Europe” shown in FIGS. 28 and 29, it is possible to add an anonymization rule by using the anonymization-rule input unit 36.

This application claims priority based on Japanese Patent Application No. 2010-250600 filed on Nov. 9, 2010, the entire contents of which are incorporated herein.

The present invention is explained above with reference to the embodiment. However, the present invention is not limited to the embodiment. Various changes understandable to those skilled in the art can be made to the configuration and the details of the present invention within the scope of the present invention.

A part of the embodiment or the entire embodiment can also be described as indicated by the following notes. However, the present invention is not limited to the below.

(Note 1) An anonymizing apparatus comprising: a generalizing unit configured to generalize, for each data entry of a data set having a plurality of data entries each including at least one attribute data forming a quasi-identifier, which is information that can identify an individual, and at least one attribute data other than the quasi-identifier, a value of the at least one attribute data forming the quasi-identifier on the basis of a predetermined generalization rule; an entry selecting unit configured to select, among the plurality of data entries included in the data set, a data entry which, when generalized on the basis of the generalization rule, becomes a factor for the data set to fail to satisfy a predetermined standard of anonymity, and at least one data entry of which generalization target attribute data has a value that is common to that data entry to thereby enable the data set to satisfy the predetermined standard of anonymity; and an entry processing unit configured to change, for the data entries selected by the entry selecting unit, the value of the generalization target attribute data to a predetermined common value irrespective of the predetermined generalization rule.

(Note 2) The anonymizing apparatus described in Note 1, wherein the entry selecting unit selects, among the plurality of data entries included in the data set, a data entry with which the data set is unable to satisfy the predetermined standard of anonymity when the data entry is generalized on the basis of the generalization rule, and a plurality of data entries having different values of attribute data not generalized on the basis of the generalization rule among the at least one attribute data forming the quasi-identifier.

(Note 3) The anonymizing apparatus described in Note 1, wherein the entry selecting unit selects, among the plurality of data entries included in the data set, a data entry with which the data set is unable to satisfy the predetermined standard of anonymity when the data entry is generalized on the basis of the generalization rule, and at least one data entry with which the data set satisfies the predetermined standard of anonymity even if this at least one data entry is excluded from the data set.

(Note 4) The anonymizing apparatus described in Note 3, wherein the entry processing unit changes the value of the generalization target attribute data to the predetermined common value to allow the data set to satisfy the predetermined standard of anonymity, and changes a value of at least one attribute data other than the generalization target attribute data among the at least one attribute data forming the quasi-identifier to a predetermined common value.

(Note 5) The anonymizing apparatus described in any one of Notes 1 to 4, wherein, when a data entry is newly added to the data set, if the data set satisfies the predetermined standard of anonymity when a value of the added data entry and a value before change of at least one data entry among data entries, values of attribute data of which have been changed, are generalized on the basis of the generalization rule, then the entry processing unit changes, for this at least one data entry, a value of the attribute data to a value obtained by generalizing the value before the change on the basis of the generalization rule.

(Note 6) The anonymizing apparatus described in any one of Notes 1 to 5, wherein, if the data set is unable to satisfy the predetermined standard of anonymity as a result of deleting at least one data entry from the data set, the entry processing unit adds a false data entry to the data set to allow the data set to satisfy the predetermined standard of anonymity.

(Note 7) The anonymizing apparatus described in Note 6, wherein, if the data set satisfies the predetermined standard of anonymity as a result of newly adding a data entry to the data set even if the false data entry is excluded, the false data entry is deleted from the data set.

(Note 8) The anonymizing apparatus described in any one of Notes 1 to 7, further comprising an entry-selection-rule input unit configured to input a rule of selection of a data entry performed by the entry selecting unit, wherein the entry selecting unit selects the data entry on the basis of the rule input from the entry-selection-rule input unit.

(Note 9) The anonymizing apparatus described in any one of Notes 1 to 8, further comprising an entry-processing-rule input unit configured to input a rule of processing of a data entry performed by the entry processing unit, wherein the entry processing unit processes the data entry on the basis of the rule input from the entry-processing-rule input unit.

(Note 10) The anonymizing apparatus described in any one of Notes 1 to 9, further comprising a generalization-rule input unit configured to input a rule of generalization of a data entry performed by the generalizing unit, wherein the generalizing unit generalizes the data entry on the basis of the rule input from the generalization-rule input unit.

10 anonymizing apparatus

20 anonymization processing unit

22 data-set receiving unit

24 processed-data-entry selecting unit

26 data-entry processing unit

28 data-set output unit

30 processed-data-entry-selection-rule input unit

32 data-entry-processing-rule input unit

34 anonymity evaluating unit

36 generalization-rule input unit

1. An anonymizing apparatus comprising:
a generalizing unit configured to generalize, for each data entry of a data set having a plurality of data entries each including at least one attribute data forming a quasi-identifier, which is information that can identify an individual, and at least one attribute data other than the quasi-identifier, a value of the at least one attribute data forming the quasi-identifier on the basis of a predetermined generalization rule;
an entry selecting unit configured to select, among the plurality of data entries included in the data set, a data entry which, when generalized on the basis of the generalization rule, becomes a factor for the data set to fail to satisfy a predetermined standard of anonymity, and at least one data entry of which generalization target attribute data has a value that is common to that data entry to thereby enable the data set to satisfy the predetermined standard of anonymity; and
an entry processing unit configured to change, for the data entries selected by the entry selecting unit, the value of the generalization target attribute data to a predetermined common value irrespective of the predetermined generalization rule.

2. The anonymizing apparatus according to claim 1, wherein the entry selecting unit selects, among the plurality of data entries included in the data set, a data entry with which the data set is unable to satisfy the predetermined standard of anonymity when the data entry is generalized on the basis of the generalization rule, and a plurality of data entries having different values of attribute data not generalized on the basis of the generalization rule among the at least one attribute data forming the quasi-identifier.

3. The anonymizing apparatus according to claim 1, wherein the entry selecting unit selects, among the plurality of data entries included in the data set, a data entry with which the data set is unable to satisfy the predetermined standard of anonymity when the data entry is generalized on the basis of the generalization rule, and at least one data entry with which the data set satisfies the predetermined standard of anonymity even if this at least one data entry is excluded from the data set.

4. The anonymizing apparatus according to claim 3, wherein the entry processing unit changes the value of the generalization target attribute data to the predetermined common value to allow the data set to satisfy the predetermined standard of anonymity, and changes a value of at least one attribute data other than the generalization target attribute data among the at least one attribute data forming the quasi-identifier to a predetermined common value.

5. The anonymizing apparatus according to claim 1, wherein, when a data entry is newly added to the data set, if the data set satisfies the predetermined standard of anonymity when a value of the added data entry and a value before change of at least one data entry among data entries, values of attribute data of which have been changed, are generalized on the basis of the generalization rule, then the entry processing unit changes, for this at least one data entry, a value of the attribute data to a value obtained by generalizing the value before the change on the basis of the generalization rule.

6. The anonymizing apparatus according to claim 1, wherein, if the data set is unable to satisfy the predetermined standard of anonymity as a result of deleting at least one data entry from the data set, the entry processing unit adds a false data entry to the data set to allow the data set to satisfy the predetermined standard of anonymity.

7. The anonymizing apparatus according to claim 6, wherein, if the data set satisfies the predetermined standard of anonymity as a result of newly adding a data entry to the data set even if the false data entry is excluded, the false data entry is deleted from the data set.

8. The anonymizing apparatus according to claim 1, further comprising an entry-selection-rule input unit configured to input a rule of selection of a data entry performed by the entry selecting unit, wherein
the entry selecting unit selects the data entry on the basis of the rule input from the entry-selection-rule input unit.

9. The anonymizing apparatus according to claim 1, further comprising an entry-processing-rule input unit configured to input a rule of processing of a data entry performed by the entry processing unit, wherein
the entry processing unit processes the data entry on the basis of the rule input from the entry-processing-rule input unit.

10. The anonymizing apparatus according to claim 1, further comprising a generalization-rule input unit configured to input a rule of generalization of a data entry performed by the generalizing unit, wherein
the generalizing unit generalizes the data entry on the basis of the rule input from the generalization-rule input unit.
